(19) United States
(12) Patent Application Publication
(10) Pub. No.: US 2006/0202956 A1
(43) Pub. Date: Sep. 14, 2006

(54) Method for a host computer having network function to detect the motion signal of a wireless mouse

(76) Inventor: Ho-Lung Lu, Panchiao (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/073,656

(22) Filed: Mar. 8, 2005

(51) Int. Cl. G09G 5/08

(52) U.S. Cl. 345/163

(57) ABSTRACT

A method for a host computer having network function to detect the motion signal of a wireless mouse comprises the following steps of: gathering statistics of system information of the host computer; receiving ID authentication information from the wireless mouse; determining whether the wireless mouse is authenticated; activating a network online supervision and adding the online status as a consideration factor; informing a firmware in the wireless mouse to activate a user-specific mode; supervising action information of the wireless mouse and the network online information; and informing and changing the action parameters of the wireless mouse. The delay between the movement of the wireless mouse and the subsequent movement of the cursor on the computer screen can thus be decreased.

### BACKGROUND OF THE INVENTION

1. Field of the Invention

The present invention relates to a method for a host computer having a network function to detect the motion signal of a wireless mouse and, more particularly, to a method of using a program to detect the motion speed of a wireless mouse thereby decreasing the delay between the movement of a wireless mouse and the subsequent movement of the cursor on the computer screen.

2. Description of Related Art

Recent improvements in computer technology have led to great advances in computer peripheral equipment. Wireless technology has been of particular benefit for input apparatuses such as keyboards and mice.

Although wireless mice are a large improvement to a computer's hardware, it is very burdensome in terms of software requirements. In the prior art, software matching a wireless mouse increases the likelihood that a user will like their new wireless mouse. For example, in order to meet software specifications for a Microsoft Windows operating system there are regular delays between the movement of the wireless mouse and the actual movement of the cursor on the computer screen. This naturally creates frustration for the user.

### SUMMARY OF THE INVENTION

Accordingly, one object of the present invention is to propose a method for a host computer having network function to detect the motion signal of a wireless mouse thereby solving the above problems of the prior art.

The present invention provides a method for a host computer having network function to detect the motion signal of a wireless mouse. The method comprises the steps of: gathering statistics of system information of the host computer; receiving ID authentication information from the wireless mouse; determining whether the wireless mouse is authenticated; activating a network online supervision and adding the online status as a consideration factor; informing a firmware in the wireless mouse to activate a user-specific mode; supervising action information of the wireless mouse and the network online information; and informing and changing the action parameters of the wireless mouse.

The various objects and advantages of the present invention will be more readily understood from the following detailed description when read in conjunction with the appended drawing, in which:

### BRIEF DESCRIPTION OF THE DRAWINGS

FIG. 1 is a flowchart of a method for a host computer having network function to detect the motion signal of a wireless mouse according to an embodiment of the present invention; and

FIG. 2 is a flowchart of a method for a wireless mouse having network function to receive the motion signal according to an embodiment of the present invention.

### DETAILED DESCRIPTION OF PREFERRED EMBODIMENTS

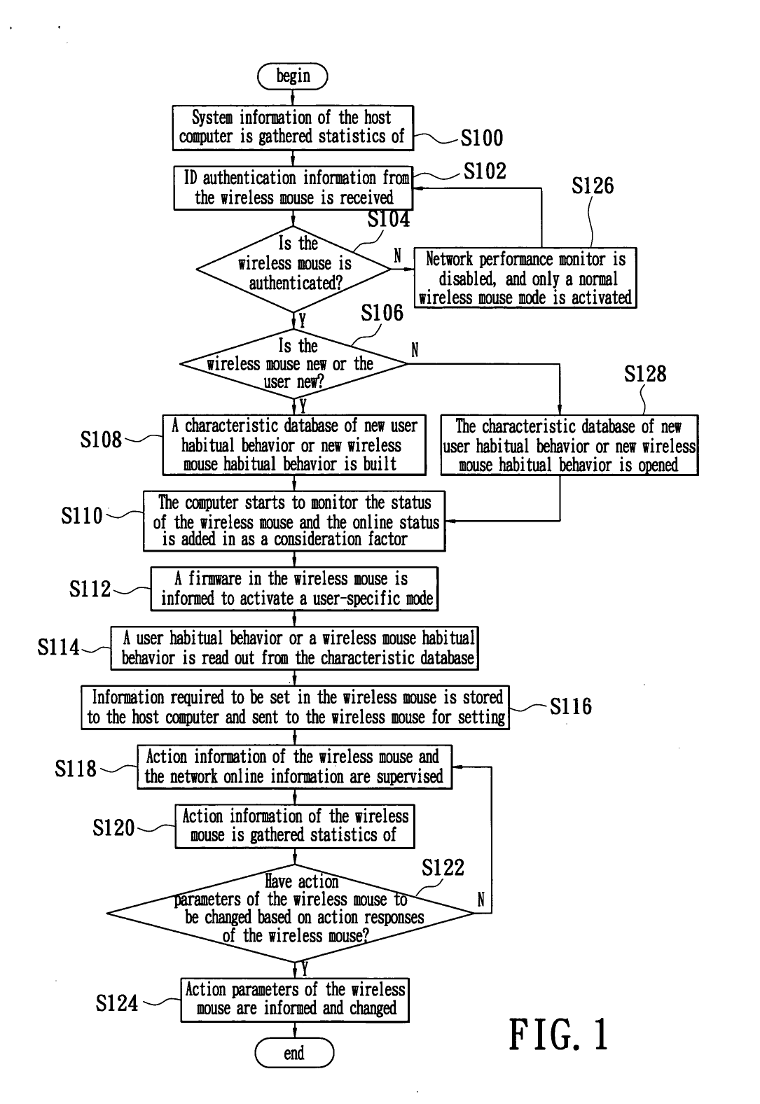

FIG. 1 is a flowchart of a method for a host computer having network function to detect the motion signal of a wireless mouse according to an embodiment of the present invention. First, system information about the host computer is gathered (Step S100). The system information regards the present usable resources of the host computer. Next, ID authentication information from the wireless mouse is received (Step S102). Whether or not the wireless mouse can be authenticated is then determined (Step S104). If the answer is yes, whether the wireless mouse or the user is new is determined (Step S106); if this cannot be determined the network performance monitor function is disabled and the wireless mouse is activated in a normal wireless mouse mode (Step S126).

During the step determining whether the wireless mouse is new or the user is new (Step 106), if the answer is yes, a characteristics database of the new user's habitual behavior or new wireless mouse's habitual behavior is created (Step S108); otherwise, an existent characteristics database for the user's habitual behavior for the wireless mouse's habitual behavior is opened (Step S128). The characteristics database is located in the wireless mouse or the host computer. Next, the computer starts to monitor the status of the wireless mouse and its status is added in as a consideration factor (Step S110). Firmware in the wireless mouse is then informed to activate a user-specific mode (Step S112).

Subsequently, a user's habitual behavior or a wireless mouse's habitual behavior is read out from the characteristics database (Step S114). Information required to be set in the wireless mouse is stored on the host computer and sent to the wireless mouse for setting (Step S116). The action information of the wireless mouse and the network online information is then supervised (Step S118). The action information of the wireless mouse is then gathered (Step S120). Whether the action parameters of the wireless mouse have to be changed based on the action responses of the wireless mouse is then determined (Step S122). If the answer is yes, the action parameters of the wireless mouse are updated and changed (Step S124); otherwise, the process begins again at Step S118.

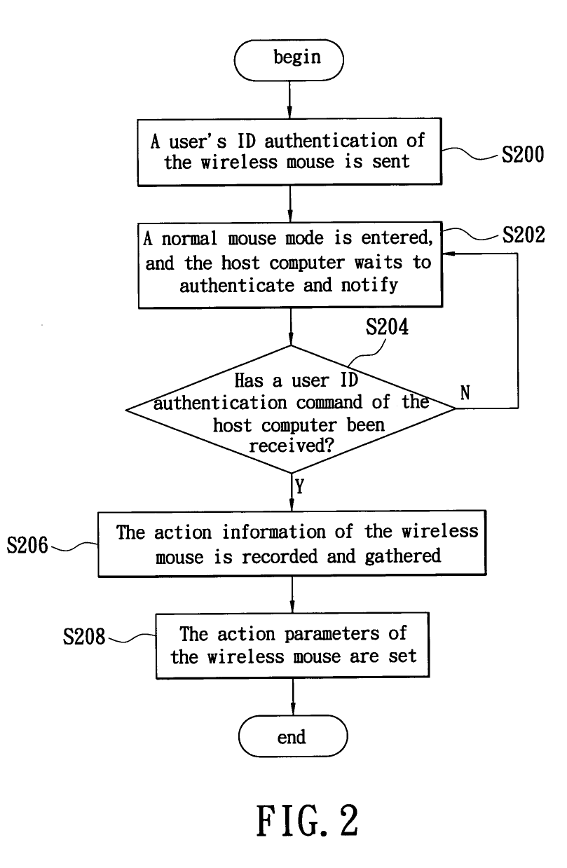

FIG. 2 is a flowchart of a method for a wireless mouse to receive the motion signal according to an embodiment of the present invention. First, a user's ID authentication of the wireless mouse is sent to a host computer (Step S200). The user's ID authentication is used to determine whether or not the user's information is stored in a database. Next, a normal mouse mode is entered, and the host computer waits to authenticate and notify the mouse (Step S202). Whether or not a user's ID authentication command from the host computer has been received is then determined (Step S204). If the answer is yes, the action parameters of the wireless mouse are set (Step S206); otherwise, the process begins again at Step S202. Finally, the action parameters of the wireless mouse are recorded and gathered (Step S208).

To sum up, the present invention can decrease the delay situation between the movement of a wireless mouse due and the cursor on a computer screen experienced in the prior art.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A method for a host computer having network function to detect the motion signal of a wireless mouse comprising the steps of:
gathering statistics of system information of said host computer;
receiving ID authentication information from said wireless mouse;
determining whether said wireless mouse is authenticated;
activating a network online supervision and adding in the online status as a consideration factor;
informing a firmware in said wireless mouse to activate a user-specific mode;
supervising action information of said wireless mouse and the network online information; and
informing and changing action parameters of said wireless mouse.

2. The method for a host computer having network function to detect the motion signal of a wireless mouse as claimed in claim 1, wherein the system information of said host computer is about the present usable resources of said host computer.

3. The method for a host computer having network function to detect the motion signal of a wireless mouse as claimed in claim 1, wherein in said step of determining whether said wireless mouse is authenticated, if the answer is yes, a step of determining whether said wireless mouse is new or the user is new is included; otherwise, a step of disabling a network performance monitor and only activating said wireless mouse in a normal wireless mouse mode is included.

4. The method for a host computer having network function to detect the motion signal of a wireless mouse as claimed in claim 3, wherein in said step of determining whether said wireless mouse is new or the user is new, if the answer is yes, a step of building a characteristics database of new user's habitual behavior or new wireless mouse's habitual behavior is included; otherwise, a step of opening a characteristics database of user's habitual behavior or wireless mouse's habitual behavior is included.

5. The method for a host computer having network function to detect the motion signal of a wireless mouse as claimed in claim 4, wherein said characteristic database is in said wireless mouse or said host computer.

6. The method for a host computer having network function to detect the motion signal of a wireless mouse as claimed in claim 1, wherein said step of informing a firmware in said wireless mouse to activate a user-specific mode further comprises:
reading a user's habitual behavior or a wireless mouse's habitual behavior from a characteristic database; and
storing information required to be set in said wireless mouse to said host computer and sending the information to said wireless mouse for setting.

7. The method for a host computer having network function to detect the motion signal of a wireless mouse as claimed in claim 1, wherein said step of supervising action information of said wireless mouse and the network online information further comprises the steps of:
gathering statistics on action information of said wireless mouse; and
determining whether to change the action parameters of said wireless mouse based on the action responses of said wireless mouse.

8. The method for a host computer having network function to detect the motion signal of a wireless mouse as claimed in claim 7, wherein in said step of determining whether to change action parameters of said wireless mouse based on action responses of said wireless mouse, said step of informing and changing action parameters of said wireless mouse is proceeded if the answer is yes; otherwise, said step of supervising action information of said wireless mouse and the network online information is restarted.

9. A method for a wireless mouse having network function to receive the motion signal comprising the steps of:
sending a user's ID authentication of said wireless mouse to a host computer;
determining whether a user ID authentication command of said host computer has been received; and
recording and gathering statistics of action parameters of said wireless mouse.

10. The method for a wireless mouse having network function to receive the motion signal as claimed in claim 9, wherein said user's ID authentication is used to determine whether said user is stored on a database.

11. The method for a wireless mouse having network function to receive the motion signal as claimed in claim 9 further comprising a step of entering a normal wireless mouse mode and waiting for said host computer to authenticate and notify after said step of sending a user's ID authentication of said wireless mouse to a host computer.

12. The method for a wireless mouse having network function to receive the motion signal as claimed in claim 9, wherein in said step of determining whether a user ID authentication command of said host computer has been received, said step of recording and gathering statistics of action parameters of said wireless mouse is proceeded if the answer is yes; otherwise, a step of entering a normal wireless mouse mode and waiting for said host computer to authenticate and notify is restarted.

13. The method for a wireless mouse having network function to receive the motion signal as claimed in claim 9 further comprising a step of setting action parameters of said wireless mouse after said step of recording and gathering statistics of action parameters of said wireless mouse.
